(19) United States
(12) Patent Application Publication
(10) Pub. No.: US 2024/0429996 A1
(43) Pub. Date: Dec. 26, 2024

(54) FILTER MANAGEMENT FOR WIDE OUTPUT BEAMS AT COVERAGE ENHANCING DEVICES

(71) Applicant: Sony Group Corporation, Tokyo (JP)

(72) Inventors: Jose FLORDELIS, Lund (SE); Chaitanya TUMULA, Åkarp (SE); Erik BENGTSSON, Eslöv (SE); Fredrik RUSEK, Eslöv (SE); Olof ZANDER, Södra Sandby (SE)

(21) Appl. No.: 18/708,048

(22) PCT Filed: Nov. 24, 2022
(86) PCT No.: PCT/EP2022/083147

§ 371 Date: May 7, 2024

(30) Foreign Application Priority Data
Nov. 26, 2021 (SE) 2151440-1

(51) Int. Cl. H04B 7/10; H04B 7/0456

(52) U.S. Cl. CPC H04B 7/10; H04B 7/0456

(57) ABSTRACT

Various aspects of the disclosure pertain to filter management procedures at coverage enhancing devices. Various examples relate to supporting spatial filters that profilter management for wide output beams at coverage enhancing devicesvide a wide beamwidth of the output beam.

### TECHNICAL FIELD

Various examples of the disclosure relate to a wireless transmission between a transmitter device and a receiver device via a coverage enhancing device. Various examples of the disclosure generally relate to a filter management procedure for configuring spatial filters at the coverage enhancing device.

### BACKGROUND

To increase a coverage area for wireless communication, it is envisioned to use reconfigurable devices, also referred to as coverage enhancing device (CED). The CED can support a wireless transmission from a transmitter device (TxD) to a receiver device (RxD). For instance, the TxD could be one of a base station (BS) of a cellular network (NW) or a wireless communication device (UE) connectable to the cellular NW; and the RxD could be one of the UE or the BS.

CEDs are also sometimes referred to as large intelligent surface (LIS) or reconfigurable intelligent surfaces (RISs). See, e.g., Sha Hu, Fredrik Rusek, and Ove Edfors. “Beyond massive MIMO: The potential of data transmission with large intelligent surfaces.” IEEE Transactions on Signal Processing 66.10 (2018): 2746-2758. The concept of CEDs thus generally includes both reflective surfaces reflecting incident electromagnetic waves, as well as transmissive surfaces, which refer to surfaces that let incident waves pass through them but can control a direction of the outgoing signals.

The CED can be implemented by an array of antennas that impose variable phase shifts onto electromagnetic waves of incident signals. The array of antennas can be passive, e.g., the array of antennas may not be able to change the amplitude of an incident signal, let alone provide amplification; but may provide a variable phase shift.

An input beam from which incident signals are accepted and an output beam into which the incident signals are redirected (e.g., reflected) can be reconfigured by changing a phase relationship between the antennas. A focus distance of input and/or output electromagnetic waves may be taken into account. This is defined by a respective spatial domain (transmission/reception) filter (or, simply, spatial filter hereinafter). The spatial filter corresponds to a transfer function that defines the relationship between electromagnetic waves of a signal incident at the CED and electromagnetic waves having been redirected the CED.

To select the appropriate spatial filter, a filter management procedure (FMP) can be used. The CED and other communication devices participate in the FMP.

At least in some modes of the FMP, it can be desirable to select a spatial filter at the CED that has a wide beamwidth of the output beam. For instance, this could be helpful where the position of the RxD is not yet known at a high accuracy or where the position of the RxD is expected to change over the course of time.

### SUMMARY

Accordingly, a need exists for advanced FMPs that support spatial filters at the CED having output beams that have a wide beamwidth.

This need is met by the features of the independent claims. The features of the dependent claims define embodiments.

According to various examples, techniques of calculating antenna weights for antennas of the CED are disclosed. Such techniques enable calculation of antenna weights that define a spatial filter that provides an output beam that has a comparatively wide beam width. Such spatial filters will be referred to as wide-beamwidth (WBW) spatial filters, hereinafter.

According to further examples, techniques of implementing an FMP to support the WBW spatial filters are disclosed. Control signalling between the TxD, RxD, and CED implementing the FMP is disclosed.

According to some examples, use of the wide beamwidth spatial filters is enabled by coordinated activation of—first—the WBW spatial filter, —second—the transmitter device using a circular polarization to transmit electromagnetic waves, and—third—the transmitter device using a single data stream across both polarization components of the circular polarization.

A method of supporting a wireless transmission from a transmitter device to a receiver device is disclosed. The wireless transmission is via a coverage enhancing device. The coverage enhancing device is reconfigurable to provide multiple spatial filters by applying, at multiple antenna elements, one or more phase shifts to electromagnetic waves of signals of the wireless transmission. Each one of the multiple antenna elements of the coverage enhancing devices associated with a respective one of two orthogonal polarization components of a polarization of the electromagnetic waves. The method includes configuring the coverage enhancing device to activate at least one predefined spatial filter of the multiple spatial filters. The method also includes, upon configuring the coverage enhancing device to activate the at least one predefined spatial filter, configuring the transmitter device to transmit the signals using a circular polarization of the electromagnetic waves.

The method may be implemented by at least one of the transmitter device, the receiver device, or the coverage enhancing device.

A computer program or a computer-program product or a computer-readable storage medium includes program code. The program code can be loaded and executed by at least one processor. Upon loading and executing the program code, the at least one processor performs a method of supporting a wireless transmission from a transmitter device to a receiver device. The wireless transmission is via a coverage enhancing device. The coverage enhancing device is reconfigurable to provide multiple spatial filters by applying, at multiple antenna elements, one or more phase shifts to electromagnetic waves of signals of the wireless transmission. Each one of the multiple antenna elements of the coverage enhancing devices associated with a respective one of two orthogonal polarization components of a polarization of the electromagnetic waves. The method includes configuring the coverage enhancing device to activate at least one predefined spatial filter of the multiple spatial filters. The method also includes, upon configuring the coverage enhancing device to activate the at least one predefined spatial filter, configuring the transmitter device to transmit the signals using a circular polarization of the electromagnetic waves.

A device for supporting a wireless transmission from a transmitter device to a receiver device is disclosed. The wireless transmission is via a coverage enhancing device. The coverage enhancing device is reconfigurable to provide multiple spatial filters by applying, at multiple antenna elements, one or more phase shifts to electromagnetic waves of signals of the wireless transmission. Each one of the multiple antenna elements of the coverage enhancing devices associated with a respective one of two orthogonal polarization components of a polarization of the electromagnetic waves. The device includes a processor. The processor is configured to configure the coverage enhancing device to activate at least one predefined spatial filter of the multiple spatial filters. The processor is further configured, upon configuring the coverage enhancing device to activate the at least one predefined spatial filter, to configure the transmitter device to transmit the signals using a circular polarization of the electromagnetic waves.

For instance, the device could be the transmitter device or the receiver device or the coverage enhancing device.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a communication system including a base station and the UE according to various examples.

FIG. 2 schematically illustrates the base station and the UE in further detail.

FIG. 3 schematically illustrates a communication system including a base station, a UE and a CED according to various examples.

FIG. 4 schematically illustrates a CED according to various examples.

FIG. 5 schematically illustrates a spatial filter provided by the CED, the spatial filter having an output beam having a narrow beamwidth according to various examples.

FIG. 6 schematically illustrates a spatial filter provided by the CED, the spatial filter having an output beam having a wide beamwidth according to various examples.

FIG. 7 is a flowchart of a method according to various examples.

FIG. 8 is a signaling diagram according to various examples.

FIG. 9 is a signaling diagram according to various examples.

FIG. 10 is a signaling diagram according to various examples.

FIG. 11 is a signaling diagram according to various examples.

### DETAILED DESCRIPTION OF EXAMPLES

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are disclosed that facilitate wireless transmission between devices of a communication system. For instance, the communication devices could be a BS of a cellular NW and a UE, or two UEs communicating in a device-to-device fashion, e.g., using a sidelink of a cellular network. A wireless transmission between a BS and a UE can be an uplink (UL) and/or downlink (DL) wireless transmission. At different times, different devices of a communication system can take the role of the TxD and the RxD, respectively. For instance, sometimes the base station may transmit, thereby implementing a DL wireless transmission; then, the UE may transmit, thereby implementing an UL wireless transmission.

According to various examples, it is possible to use multi-antenna techniques. Multi-antenna techniques are used to enhance reliability and/or throughput of wireless communication. The TxD can use precoding at multiple antennas. Thereby, a signal can be transmitted using a single data stream or can be transmitted using multiple data streams (spatial diversity or spatial multiplexing or to achieve array gain).

According to various examples of the disclosure, signals can be transmitted using a certain polarization of the respective electromagnetic waves. As a general rule, a linear polarization or a circular polarization could be used. Two orthogonal polarization components can be used to increase the number of layers by a factor of two, i.e., it would be possible that the TxD transmits signals using two data streams for the two orthogonal components. Also, two orthogonal polarization components can be used for increasing diversity. The TxD can transmit the signal using a single data stream for the two orthogonal polarization components. The two orthogonal polarization components could be components of a linear polarization, e.g., horizontal and vertical (H-POL and V-POL, respectively); or could be left-circular and right-circular (L-CIR-POL and R-CIR-POL) polarization components of a circular polarization.

According to various examples, the communication system can include a CED. The wireless transmission from TxD to RxD is via the CED. There may be, in principle, additional reflection on objects other than the CED.

To forward/redirect an incident signal, the CED may not decode the signal. The CED may not translate an incident signal into the baseband. Rather, a reflection and, if possible, amplification of the RF signals can be used. Variable phase changes across the CED can be applied. This enables to steer the outgoing signals appropriately. This is explained in further detail below.

As a further general rule, the CED is configured to employ multi-antenna techniques. In particular, the CED is reconfigurable to provide multiple spatial filters; different spatial filters can be applied at different points in time. Thereby, electromagnetic waves can be diverted. Each one of the multiple spatial filters is associated with a respective input beam from which incident signals are accepted (this defines an angle-of-arrival, AoA), as well as with a respective output beam into which incident signals are reflected or amplified by the CED (this defines an angle-of-departure, AoD). Each output beam has a respective output spatial direction, a beam width, etc.

The CED includes multiple antenna elements. For instance, the antenna elements could be antenna ports. The antenna elements can form an array. The antenna elements interact with the incident electromagnetic waves of signals transmitted by the TxD. The antenna elements could be implemented by reflective elements. The antenna elements could be implemented by a metamaterial surface. For example, the antenna elements could be implemented by mechanically actuatable antennas or reflective mini-surfaces. Liquid crystals could be used.

Accordingly, a CED can include multiple antenna elements where each antenna element, 1) receives a signal, 2) applies a phase change and optionally changes the amplitude, and 3) radiates the signal. Depending on the pattern of applied phase changes, the spatial properties of the CED change. This means that the signal strength for a certain pair of AoAs and AoDs (as seen from the RIS) depends on the phase change pattern.

The multiple antenna elements can be polarized antenna elements, i.e., each antenna element may be configured to individually and/or collectively influence the polarization of the electromagnetic waves of the incident signal (e.g., rotate the polarization direction). According to examples, orthogonal components of a polarization (e.g., circular or linear polarization) of electromagnetic waves of an incident signal may be differently affected by the antenna elements of the CED. Each individual antenna element may selectively reflect electromagnetic waves of one of two orthogonal components of the electromagnetic waves. The orthogonality between the two components of the polarization of the electromagnetic waves of the incident signals may be maintained, so that in principle the RxD can independently decode for each polarization component. It would be possible to support two data streams using the two orthogonal components of the polarization. Also, a diversity mode would be possible.

Next, details with respect to the control of the CED are explained. As a general rule, there can be a control device that configures the CED.

There are many schools-of-thought for how CEDs should be integrated into 3GPP-standardized RANs. Three options are summarized in TAB. 1 below.

TABLE 1
Multiple options for deploying a CED in a communication
system that includes a BS of a cellular NW and a UE.
All options are supported by the FMPs disclosed herein.

| | Brief | |
|---|---|---|
| | explanation | Example details |
| 1 | BS- | In an exemplary case, the NW operator has |
| | controlled | deployed the CEDs and is therefore in full control |
| | CED | of the CED operations. The UEs, on the other hand, |
| | | may not be aware of the presence of any CED, at |
| | | least initially, i.e., it is transparent to a UE whether it |
| | | communicates directly with the BS or via a CED. |
| | | The CED essentially functions as a coverage-ex- |
| | | tender of the BS. The BS may have established a |
| | | control link with the CED. |
| | | As part of a FMP for selecting the appropriate |
| | | spatial filter at the CED, the BS can then provide a |
| | | control message on the control link to activate a |
| | | given selected spatial filter. For instance, a filter |
| | | codebook can be used, along with respective |
| | | indices that are signaled. |
| 2 | UE- | According to another exemplary case, it might be a |
| | controlled | private user or some public entity that deploys the |
| | CED | CED. Further, it may be that the UE, in this case, |
| | | controls CED operations. The BS, on the other |
| | | hand, may not be aware of the presence of any |
| | | CED and, moreover, may not have control over |
| | | it/them whatsoever. The UE may gain awareness of |
| | | the presence of CED by means of some short-range |
| | | radio technology, such as Bluetooth, wherein Blue- |
| | | tooth may refer to a standard according to |
| | | IEEE 802.15, or WiFi, wherein WiFi may refer to a |
| | | standard according to IEEE 802.11, by virtue of |
| | | which it may establish the control link with the CED. |
| | | Ultrawideband communication can be used. It would |
| | | be possible to use an in-band signaling protocol. |
| | | As part of a FMP for selecting the appropriate |
| | | spatial filter at the CED, the UE can then provide a |
| | | control message on the control link to activate a |
| | | given selected spatial filter. For instance, a filter |
| | | codebook can be used, along with respective |
| | | indices that are signaled. |
| 3 | CED | In another option, the activation of a specific spatial |
| | autonomous | filter may be decided at the CED. The CED may |
| | selection of | then inform, via a control link, e.g., the BS or the |
| | spatial filter | UE. |

Various techniques are concerned with facilitating an FMP for selecting and configuring the appropriate spatial filter at the CED to support a wireless transmission from a TxD to a RxD. The disclosure covers scenarios according to TAB. 1. The FMP can include actions at the TxD and/or the RxD, as well as at the CED.

For instance, multiple modes of an FMP are conceivable. Some modes are summarized below in TAB. 2. Such modes may be used for communicated in UL and/or DL and/or for sidelink or device-to-device communication.

TABLE 2
various examples of modes of an FMP. As explained above,
the different modes of the FMP rely on spatial filters that have
output beams of different beam widths.

| Mode | |
|---|---|
| name | Example description |
| Closed- | For instance, a closed-loop beam tracking mode of the |
| loop | FMP may be activated for a UE that operates in a con- |
| beam | nected mode. This means that the UE is registered at the |
| tracking | cellular NW and a data connection is established between |
| | the BS and the UE. Reference signals (also referred to as |
| | pilot signals) that enable sounding of the channel are |
| | transmitted from the BS to the UE and/or from the UE to |
| | the BS. By means of the reference signals, changes in the |
| | channel between the BS and the UE can be tracked. It is |
| | then possible to adjust the spatial filter, to realign the |
| | output beam of the spatial filter with the position of the UE. |
| | Typically, a spatial filter providing an output beam having |
| | a narrow beamwidth is used to enhance coverage and |
| | increase the signal-to-noise ratio. |
| | However, with a narrow beamwidth of the output beam, it |
| | is critical that the position of the RxD is known. A slight |
| | change of positions ruins the signals strength and |
| | connection is lost. This may trigger a transition to |
| | the beam sweeping mode of the FMP, see below. |
| Beam | A beam sweeping mode of the FMP may correspond to |
| sweeping | repetitive transmission of a given signal using |
| | different output beams. I.e., a sequence of different |
| | spatial filters is activated at the CED. A burst |
| | of the signal can be transmitted, wherein different |
| | instances of the signal are forwarded by the reflective |
| | device using different ones of the spatial filters of |
| | the sequence of different spatial filters. Thereby, the |
| | signal can be effectively transmitted to a wide solid angle |
| | in the surrounding of the CED, the wide solid angle being |
| | covered by multiple output beams that have a |
| | comparatively small beamwidth. Nonetheless, the |
| | beamwidth of the output beams defined by the spatial |
| | filters of the sequence of different spatial filters can be |
| | larger than the beamwidth of any output beam used in |
| | the closed-loop beam tracking mode, as discussed above. |
| | A WBW spatial filter may be used. |
| | The purpose of the beam sweeping mode may be to |
| | acquire a specific output beam that is providing good |
| | channel characteristics for the wireless transmission. Once |
| | this output beam (and, accordingly, the appropriate spatial |
| | filter) has been identified, a transition to the closed-loop |
| | beam tracking mode of the FMP can occur. |
| | Accordingly, the beam sweeping mode is sometimes |
| | also referred to as beam acquisition mode. |
| | For instance, the beam sweeping mode may be used |
| | during initial access of a UE to the cellular NW. Here, the |
| | location of the UE with respect to the BS may be unknown. |
| | For instance, the beam sweeping mode may include a |
| | closed-loop refinement. For instance, the BS may use |
| | multiple wide beams for a first iteration of a beamsweep and |
| | based on feedback from the UE may use narrower beams |
| | in a second iteration of the beamsweep, the narrower |
| | beams being aligned with the feedback beam of the first |
| | iteration of the beamsweep. |
| Single | In the single broad beam mode of the FMP a spatial filter |
| broad | may be activated at the CED that has an output beam that |
| beam | is wide, i.e., has a wide beamwidth. Thereby, the signal |
| | can be effectively transmitted to a wide solid angle in the |
| | surrounding of the CED. Typically, an output beam may be |
| | used that has a wider beamwidth if compared to the |
| | beamwidth of output beams used in the closed-loop beam |
| | tracking mode or the beam sweeping mode, as discussed |
| | above. |
| | A WBW spatial filter may be used. |
| | For instance, this may be helpful where signals are broad- |
| | casted, i.e., a signal is not specifically targeting an individ- |
| | ual UE, but is rather intended to target multiple UEs in the |
| | surrounding of the CED. The idea is that by using a spatial |
| | filter that has an output beam that has a wide beamwidth, a |
| | larger number of RxDs can be reached. |
| | In another example, the single broad beam mode may be |
| | used during initial access of a UE to the cellular NW. Here, |
| | the location of the UE with respect to the BS may be |
| | unknown |

As a general rule, various definitions of a beamwidth are possible. One example definition of beamwidth is the angle between the half-power (−3 dB) points of the main lobe of the radio antenna pattern, when referenced to the peak effective radiated power of the main lobe.

Various examples of the disclosure facilitate configuring spatial filters at the CED that have output beams that provide a wide beamwidth. This can facilitate, e.g., beam-sweeping operation, beam acquisition operation or broadcasting operation in respective modes of the FMP procedure, see TAB. 2.

For instance, WBW spatial filters may be configured that have beamwidths of the respective output beam not smaller than 20°, optionally not smaller than 50°, further optionally not smaller than 120°.

Typically, the beamwidth of a beam is inversely proportional to the aperture of the antenna array that generates the beam. Equivalently, it is inversely proportional to the number N of antenna elements, assuming inter-element spacing does not change with N. With this in mind, a relatively wide beamwidth of a WBW spatial filter can be achieved where the actual beamwidth is larger or much larger than it could be expected from the number of antenna elements. For example, a CED with 8×8 antenna-element arrays covering an azimuthal angle of 120 degrees are available. For this case, the “natural” beamwidth would be 120/8=15 degrees. Hence, 50 degrees could be considered a “wide” beam in absolute terms for such 8×8 CED.

A ruleset for determining antenna weights of a WBW spatial filter—i.e., for determining the respective phase changes applied at each antenna element of the CED—is provided below.

Assume a dually-polarized TxD and RxD (i.e., having antenna elements that can individually sense two orthogonal components of a linear polarization of the electromagnetic waves; i.e., linearly polarized signals and linearly polarized antenna elements are considered) and a CED with M horizontally polarized antennas and M vertically polarized antennas. Without any polarization rotations along the channels between TxD-CED and CED-RxD, respectively, the system model can be expressed as:

$$[ \begin{matrix}{z}_{A} \\ {z}_{B}\end{matrix} ] = [ \begin{matrix}{b}^{T} ( φ ) & {0}_{1 \times M} \\ {0}_{1 \times M} & {b}^{T} ( φ )\end{matrix} ] [ \begin{matrix}diag ( {w}_{A} ) & 0 \\ 0 & diag ( {w}_{B} )\end{matrix} ] [ \begin{matrix}a ( θ ) & {0}_{M \times 1} \\ {0}_{M \times 1} & a ( θ )\end{matrix} ] [ \begin{matrix}{x}_{A} \\ {x}_{B}\end{matrix} ] . \qquad ( 1 )$$

where x_{A} are the transmitted/signals for vertical polarizations component; z_{A} are the received signals for the vertical polarization component; x_{B} are the transmitted signals for the horizontal polarization component; and z_{B} are the received signals for the horizontal polarization component. The two (1×M) vectors a(θ) and b(φ) are steering vectors from the TxD to the CED and the CED to the RxD, respectively. The arguments of the steering vectors, namely θ, φ, are spherical angles (i.e., have two components) corresponding to directions. w_{A} and w_{B} denote the phase changes applied at the horizontally and vertically polarized CED antennas, respectively (i.e., w_{A} and w_{B} define the antenna weights of the spatial filters).

Now, assume that x_{A}=x_{B}=1. The power profile of the output beam (radiation pattern) of a WBW spatial filter can be defined as P(θ, φ):=|z_{A}|²+|z_{B}|².

This means that the total transmitted power along the output beam at a given direction φ, i.e., the sum of powers from the two orthogonal polarizations, defines the radiation pattern. This is referred to as a dual-polarization radiation pattern.

The dual-polarization radiation pattern rests on the assumption that, for a given angle covered by the output beam—i.e., for a given output direction, i.e., AoD, defined by spherical angles φ−, different gains are provided for the two orthogonal polarization components; on the other hand, the sum of powers of orthogonal polarization unit vectors, i.e., the power profile of the dual-polarization radiation pattern, should be constant for all angles at any instant in time.

Assuming now that instead of M antenna elements per polarization there are 2M antenna elements. There is a general tendency that the increased count of the antenna array reduces the beamwidth of the output beam of the spatial filter at the CED.

To counteract this dependency, an iterative calculation of the antenna weights of a WBW spatial filter as described in TAB. 3 can be applied:

TABLE 3
Iterative calculation of antenna weights of a WBW spatial filter.
This iterative calculation follows the technique described by
Petersson and Girnyk. However, Petersson and Girnyk describe
calculation of precoders for a TxD, but various techniques are
based on the finding that generally a similar approach can be
applied to CEDs. The technical effect of such iterative calculation
is that the radiation pattern of the WBW spatial filter obtained for
the large-size antenna array of the CED P(θ, φ) is a scaled version
of the initial radiation pattern of the protoarray P₀(θ, φ), i.e.,
P(θ, φ) ∝ P₀(θ, φ). This helps to construct the WBW spatial filter
that defines an output beam having a wide beamwidth.

| Calculation | |
|---|---|
| step | Explanation |
| (1) | Select a small M, such as 2, 3, 4, . . . |
| | This is a hypothetical “protoarray” of antenna |
| | elements used for calculation purposes. Select |
| | the antenna weights w_{A} and w_{B}, for example |
| | by constructing an output beam that has a desired |
| | shape. Due to the comparatively small M this is a |
| | task that can be solved using routine techniques or |
| | even trial-and-error. Further, due to the small M, it |
| | is possible to set the antenna weights to obtain an |
| | output beam that has a significant beam width, e.g., at |
| | least 45° or even at least 90°. Denote by P₀(θ, φ) the |
| | initial radiation pattern obtained for the protoarray. |
| (2) | Double M. |
| (3) | Find a new pair w_{A} and w_{B} of double lengths |
| | from the old pair by using predefined |
| | rules as described in Petersson, Sven |
| | O., and Maksym A. Girnyk. ″Energy- |
| | Efficient Design of Broad Beams for Massive |
| | MIMO Systems.″ arXiv preprint arXiv:2012.02768 |
| | (2020). See specifically id. “Algorithm |
| | 1 ULA Expansion″ and “Algorithm 2 URA |
| | expansion”. This is also further disclosed in Girnyk, |
| | Maksym A., and Sven O. Petersson. ″Efficient Cell- |
| | Specific Beamforming for Large Antenna Arrays.″ |
| | IEEE Transactions on Communications (2021) |
| | for arbitrary numbers of antenna elements. |
| (4) | Repeat (2) and (3) if M has not yet reached count of |
| | antenna elements of CED. |

Various scenarios are based on the finding that the behavior of such WBW spatial filter obtained from the iterative calculation outlined in TAB. 3 can be affected by an impact of the channel between the TxD and the CED. This is explained below.

In many cases, there is a rotation of the polarization components due to the channel between TxD and CED. With polarization rotations the input-output relation of (1) is modified to:

$$[ \begin{matrix}{z}_{A} \\ {z}_{B}\end{matrix} ] = R ( {ϑ}_{2} ) [ \begin{matrix}{b}^{T} ( φ ) & {0}_{1 \times M} \\ {0}_{1 \times M} & {b}^{T} ( φ )\end{matrix} ] [ \begin{matrix}diag ( {w}_{A} ) & 0 \\ 0 & diag ( {w}_{B} )\end{matrix} ] [ \begin{matrix}a ( θ ) & {0}_{M \times 1} \\ {0}_{M \times 1} & a ( θ )\end{matrix} ] R ( {ϑ}_{1} ) [ \begin{matrix}{x}_{A} \\ {x}_{B}\end{matrix} ] . \qquad ( 2 )$$

where

$$R ( ϑ ) = [ \begin{matrix}cos ϑ & - s in ϑ \\ sin ϑ & cos ϑ\end{matrix} ]$$

is a rotation matrix, and ϑ₁ is the rotation of the polarization along the channel between TxD and CED and ϑ₂ is the rotation of the polarization along the channel between CED and RxD. For antenna weights of a WBW spatial filter that are calculated according to TAB. 3, one obtains:

$$[ \begin{matrix}{b}^{T} ( φ ) & {0}_{1 \times M} \\ {0}_{1 \times M} & {b}^{T} ( φ )\end{matrix} ] [ \begin{matrix}diag ( {w}_{A} ) & 0 \\ 0 & diag ( {w}_{B} )\end{matrix} ] [ \begin{matrix}a ( θ ) & {0}_{M \times 1} \\ {0}_{M \times 1} & a ( θ )\end{matrix} ] = [ \begin{matrix}{d}_{A} & 0 \\ 0 & {d}_{B}\end{matrix} ] \qquad ( 3 )$$

where, in general, d_{A}≠d_{B}.

$$[ \begin{matrix}{d}_{A} & 0 \\ 0 & {d}_{B}\end{matrix} ]$$

can be referred to as the effective CED transfer function, i.e., the spatial filter. Note: the actual CED transfer function would be

$$[ \begin{matrix}diag ( {w}_{A} ) & 0 \\ 0 & diag ( {w}_{B} )\end{matrix} ] ,$$

as used in Eq. (2).

The dual-polarization radiation pattern is given by (θ, φ)=|d_{A}|²+|d_{B}|², as explained above. Further, P(θ, φ)∝P₀(θ, φ), as explained above.

To qualify as a wide beam, the requirement must hold that |z_{A}|²+|z_{B}|² is a constant irrespective of the polarization rotations ϑ₁, ϑ₂ (otherwise, the beamwidth would be dependent on the undefined or uncontrolled polarization rotation of the channel); further, this must be true for a fixed transmitted polarization

$$[ \begin{matrix}{x}_{A} \\ {x}_{B}\end{matrix} ] ,$$

i.e., for a polarization of the electromagnetic waves transmitted at the TxD.

Various techniques are based on the finding that using a linear polarization at the TxD, e.g.,

$$[ \begin{matrix}{x}_{A} \\ {x}_{B}\end{matrix} ] = [ \begin{matrix}1 \\ 1\end{matrix} ] ,$$

violates this requirement, as shown below

$$\begin{matrix}{\vert {z}_{A} \vert}^{2} + {\vert {z}_{B} \vert}^{2} = [ \begin{matrix}1 & 1\end{matrix} ] {R}^{T} ( {ϑ}_{1} ) [ \begin{matrix}{d}_{A}^{2} & 0 \\ 0 & {d}_{B}^{2}\end{matrix} ] R ( {ϑ}_{1} ) [ \begin{matrix}1 \\ 1\end{matrix} ] \\ = {d}_{A}^{2} + {d}_{B}^{2} + 2 cos ( {ϑ}_{1} ) sin ( {ϑ}_{1} ) [ {d}_{A}^{2} - {d}_{B}^{2} ]\end{matrix} \qquad ( 4 )$$

The expression of Eq. 4 is not constant since generally d_{A}≠d_{B}.

Various techniques are based on the finding that using a circular polarization at the TxD fulfills this requirement, as shown below.

The matrix R(ϑ₁) is a rotation matrix, and as such it is well known that it has eigen-vectors

$$[ \begin{matrix}1 \\ i\end{matrix} ] and [ \begin{matrix}1 \\ - i\end{matrix} ] .$$

Note that

$$[ \begin{matrix}1 \\ i\end{matrix} ] and [ \begin{matrix}1 \\ - i\end{matrix} ]$$

represent the right- and left-hand circularly polarized signals.

For example, for

$$[ \begin{matrix}{x}_{A} \\ {x}_{B}\end{matrix} ] = [ \begin{matrix}1 \\ i\end{matrix} ] - i . e . ,$$

where the right-hand circular polarized electromagnetic waves are transmitted by the TxD, one obtains

$$\begin{matrix}{\vert {z}_{A} \vert}^{2} + {\vert {z}_{B} \vert}^{2} = [ 1 - i ] {R}^{T} ( {ϑ}_{1} ) [ \begin{matrix}{d}_{A}^{2} & 0 \\ 0 & {d}_{B}^{2}\end{matrix} ] R ( {ϑ}_{1} ) [ \begin{matrix}1 \\ i\end{matrix} ] \\ = [ 1 - i ] [ \begin{matrix}{d}_{A}^{2} & 0 \\ 0 & {d}_{B}^{2}\end{matrix} ] [ \begin{matrix}1 \\ i\end{matrix} ] \\ = {d}_{A}^{2} + {d}_{B}^{2}\end{matrix} \qquad ( 5 )$$

where it is exploited that the eigenvalues of rotation matrices are of unit magnitude. The implication of the above equation is that the radiation pattern of the WBW spatial filter is invariant of the polarization rotation, and only depends on the antenna weights given by w_{A} and w_{B}. This also applies for left-hand circularly polarized electromagnetic waves.

Accordingly, according to various examples, where a CED is configured to activate at least one predefined spatial filter—e.g., a WBW spatial filter—of multiple spatial filters, the TxD can be configured to transmit the signal using a circular polarization of the electromagnetic waves.

It is noted that a transfer function of the type

$$[ \begin{matrix}{d}_{A} & 0 \\ 0 & {d}_{B}\end{matrix} ]$$

with d_{A}≠d_{B} is observed when constructing the WBW spatial filter using the method of TAB. 3. Such transfer function is not observed for other types of designs for spatial filters. For example, it does not occur for standard narrow beam designs. However, for this special structure of the WBW spatial filter, the polarization used by the TxD is critical.

Where two devices of a communication system alternatingly act as TxD, both devices may be configured to transmit respective signals using the circular polarization of the electromagnetic waves. Alternatively, a device can match its transmit polarization to the polarization of the received signal.

Using the WBW spatial filter can be helpful, e.g., for a beam-sweeping or beam-acquisition mode, a broadcasting mode, or generally a single wide beam mode of the FMP. See TAB. 3. For beam tracking mode, conversely, narrow output beams may be preferred.

Due to the dual-polarization radiation pattern of a WBW spatial filter, where the sum of power across orthogonal polarization components (e.g., H-POL and V-POL) is constant, the TxD may be requested to transmit the signal using either a circularly polarized signal or a signal that matches the polarization of a transmitted signal or an earlier received signal, when the WBW spatial filter is active.

Thus, for beam tracking mode—typically relied upon when a UE operates in the connected mode where significant amounts of data are transferred—it may be beneficial to use another non-WBW spatial filter that can operate using two data streams for two orthogonal polarization components, e.g., H-POL and V-POL polarization components in case of a linear polarization or L-CIR-POL or R-CIR-POL for a circular polarization. Thus, for beam tracking mode, it may be preferred to use spatial filters that are not relying on a dual-polarization radiation pattern according to a construction of TAB. 3.

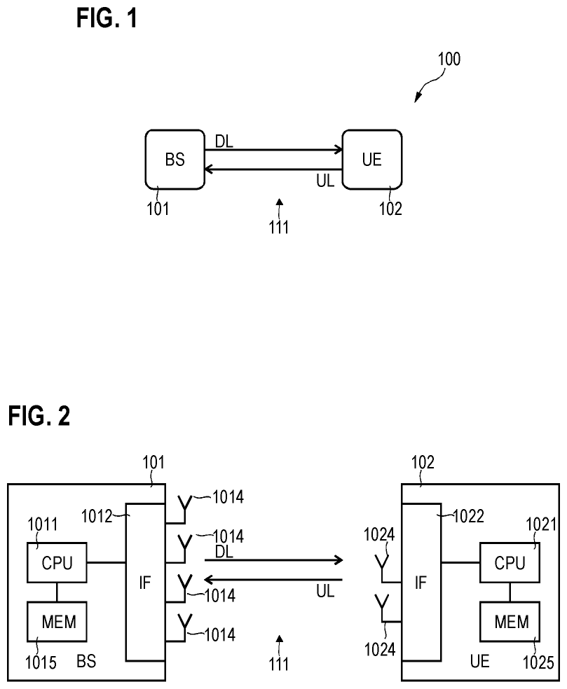

FIG. 1 schematically illustrates a communication system 100. The communication system includes two devices 101, 102 that are configured to communicate with each other using a wireless transmission 111 (e.g., a wireless channel). In the example of FIG. 1, the device 101 is implemented by an access node, more specifically a BS, and the device 102 is implemented by a UE. The BS 101 can be part of a cellular NW (not shown in FIG. 1).

As a general rule, the techniques described herein could be used for various types of communication systems, e.g., also for device-to-device communication, etc. For the sake of simplicity, however, hereinafter, various techniques will be described in the context of a communication system that is implemented by a BS 101 of a cellular NW and a UE 102.

As illustrated in FIG. 1, there can be DL communication, as well as UL communication. Various examples described herein particularly focus on the DL communication from the BS 101 to the UE 102. However, similar techniques may be applied to UL communication from the UE 102 to the BS 101. Also, sidelink communication between peer devices can be subject to the techniques described herein.

FIG. 2 illustrates details with respect to the BS 101. The BS 101 implements an access node to a communications network, e.g., a 3GPP-specified cellular network. The BS 101 includes control circuitry that is implemented by a processor 1011 and a non-volatile memory 1015. The processor 1011 can load program code that is stored in the memory 1015. The processor 1011 can then execute the program code. Executing the program code causes the processor to perform techniques as described herein, e.g.: participating in an FMP for selecting a spatial filter at a CED (not shown in FIG. 2); transmitting and/or receiving (communicating) signals using one or more data streams and using a linear or circular polarization of respective electromagnetic waves; communicating with the CED on a control link; communicating with the UE 102, e.g., on a respective control link and/or payload data; providing configuration information to the CED for configuring a spatial filter at the CED; etc.

FIG. 2 also illustrates details with respect to the UE 102. The UE 102 includes control circuitry that is implemented by a processor 1021 and a non-volatile memory 1025. The processor 1021 can load program code that is stored in the memory 1025. The processor can execute the program code. Executing the program code causes the processor to perform techniques as described herein, e.g.: participating in an FMP for selecting a spatial filter at a CED (not shown in FIG. 2); transmitting and/or receiving (communicating) signals using one or more data streams and using a linear or circular polarization of respective electromagnetic waves; communicating with the CED on a control link; communicate with the BS 101, e.g., on a respective control link and/or payload data; providing configuration information to the CED for configuring a spatial filter at the CED; etc.

FIG. 2 also illustrates details with respect to the wireless transmission 111 between the BS 101 and the UE 102. The BS 101 includes an interface 1012 that can access and control multiple antennas 1014. Likewise, the UE 102 includes an interface 1022 that can access and control multiple antennas 1024.

While the scenario of FIG. 2 illustrates the antennas 1014 (they may be referred to as antenna elements) being coupled to the BS 101, as a general rule, it would be possible to employ transmit-receive points (TRPs) that are spaced apart from the BS.

The interfaces 1012, 1022 can each include one or more TX chains and one or more RX chains. For instance, such RX chains can include low noise amplifiers, analogue to digital converters, mixers, etc. Analogue and/or digital beamforming would be possible. Thereby, phase-coherent transmitting and/or receiving (communicating) can be implemented across the multiple antennas 1014, 1024. Multi-antenna techniques can be implemented.

By using a TX beam, the direction of signals transmitted by a transmitter of the communication system is controlled. Energy is focused into a respective direction or even multiple directions, by phase-coherent superposition of the individual signals originating from each antenna 1014, 1024. Thereby, a data stream can be directed. The data streams transmitted on multiple beams can be independent, resulting in spatial multiplexing multi-antenna transmission; or dependent on each other, e.g., redundant, resulting in diversity multi-input multi-output (MIMO) transmission.

Signals can be transmitted using a linear polarization of the electromagnetic waves, i.e., using H-POL and V-POL polarization components. Thereby, per TX beam, two independent data streams—having H-POL and V-POL—can be implemented. It would also be possible to implement a single data stream using H-POL and V-POL polarization components, i.e., use polarization diversity.

Signals can be transmitted using a circular polarization of the electromagnetic waves, i.e., using L-CIR-POL and R-CIR-POL polarization components. Thereby, per TX beam, two independent data streams—having L-CIR-POL and R-CIR-POL—can be implemented. It would also be possible to implement a single data stream using L-CIR-POL and R-CIR-POL polarization components, i.e., use polarization diversity.

As a general rule, alternatively or additionally to such TX beams, it is possible to employ RX beams. These RX beam can be selective to receive signals having H-POL or V-POL; or L-CIR-POL and R-CIR-POL, respectively.

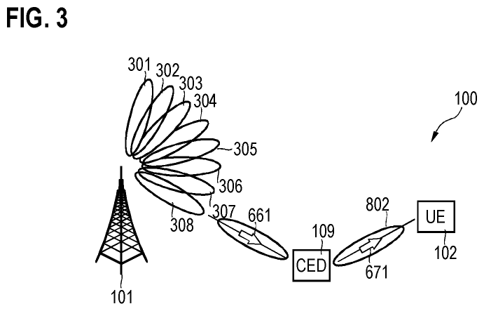

FIG. 3 illustrates aspects with respect to communicating via a CED 109. The UE 102 is served by the BS 101 via a CED 109.

The BS 101 uses a DL TX beam 308 to transmit signals—e.g., data signals and/or RSs—towards the CED 109. Typically, the relative positioning between the BS 101 and the CED 109 can be assumed to be static.

Therefore, the DL TX beam 308 is relatively static. While FIG. 3 illustrates a line-of-sight communication, as a general rule, also non-line-of-sight communication would be possible.

The signals arrive at the CED 109 at an input direction 661. The CED 109 applies a spatial filter that defines an AoD 671 towards the UE 102. More specifically, a respective output beam 802 is defined, e.g., having a certain beamwidth, etc. The spatial filter also defines the input direction 661 from which the incident signals are accepted; a respective input beam is also shown in FIG. 3.

Due to UE mobility, it can be required from time to time to reconfigure another spatial filter at the CED 109 to define another output direction. This is facilitated by an FMP, as disclosed herein.

The beam management at the UE 102 to configure the appropriate DL RX beam or UL TX beam is out-of-scope of this disclosure; reference techniques are available.

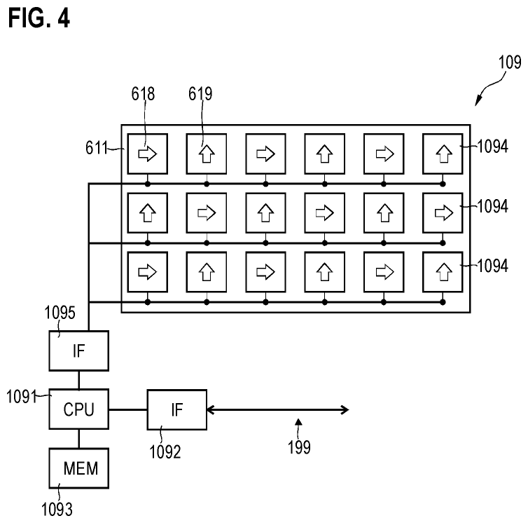

FIG. 4 illustrates aspects in connection with the CED 109. The CED 109 includes an array of polarized antenna elements 1094 each imposing a respective configurable phase shift when reflecting or re-transmitting or attenuating incident electromagnetic waves having a respective polarization component 618, 619.

The array of antenna elements 1094 in the illustrated example is passive; i.e., the antenna elements 1094 may not be able to change, e.g., amplify, the amplitude of the incident electromagnetic waves. This array of antenna elements 1094 forms a reflective surface 611. A continuous or quantized phase shift can be imposed.

Each antenna element 1094 can locally provide a respective phase shift, i.e., each antenna element 1094 may be individually configured using respective antenna weights w_{A} and w_{B}. For meta-materials these antenna weights can collectively impact multiple sub-wavelength antenna elements.

The CED 109 also includes a processor 1091 and the memory 1093. The processor 1091 can load program code from the memory 1093 and execute the program code. Upon loading and executing the program code, the processor 1091 can (re-)configure the antenna elements 1094 to implement a respective spatial filter, via a respective control interface 1095. There is also provided a communication interface 1092 via which the processor 1091 can communicate on a control link 199. Control messages or capability messages or other information can be exchanged between a device controlling the CED 109 and the CED 109, e.g., the BS 101 or the UE 102 (cf. TAB. 1).

For instance, the control link 199 could be implemented using Bluetooth or Wi-Fi technology. The control link 199 can be implemented using a wired channel or a wireless channel. The wireless channel can be out-of-band or in-band with the wireless transmission 111 between the BS 101 and the UE 102. For an in-band control link it may be so that the CED 109 has the capability to decode in-band control messages which are addressed to the CED 109. Note that such messages are terminated at the CED 109 and need not be forwarded. This would require respective processing and storage capabilities compared to decoding and forwarding data intended to be reflected off to other devices. For example, short control messages may be sent on the control link 199 occupying a small bandwidth and sparsely in time. On the other hand, user data that needs to be forwarded may be continuously sent using a large or very large bandwidth.

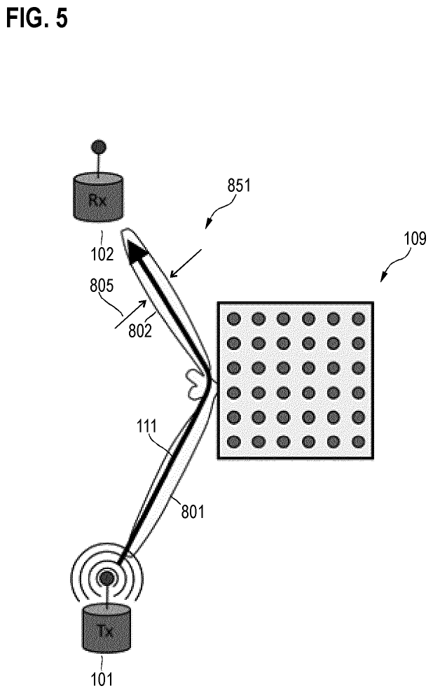

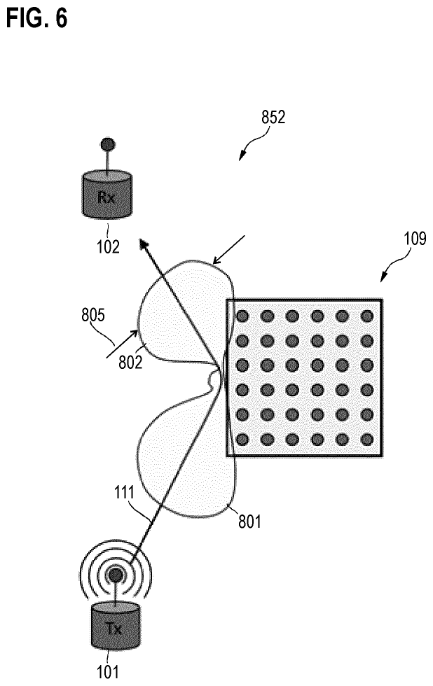

The reconfiguration of antenna elements 1094 defines respective spatial filters that are associated with spatial directions from which incident signals are accepted and spatial directions into which incoming electromagnetic waves are reflected, i.e., on a macroscopic level. Details with respect to the spatial filters are explained in FIG. 5 and FIG. 6.

FIG. 5 schematically illustrates aspects with respect to an input beam 801 and an output beam 802 of an associated spatial filter 851 activated at the CED 109. The output beam 802 (as well as the input beam 801) has a comparatively narrow beamwidth 805; specifically, if compared to the beamwidth 805 of the output beam 802 provided by the WBW spatial filter 852 illustrated in FIG. 6. For instance, it would be possible that the antenna weights of the WBW spatial filter 852 are calculated using the iterative calculation according to TAB. 3. For instance, the WBW spatial filter 852 can be labeled, in a respective filter codebook, as defining the output beam 802 having a wide beamwidth 805. The WBW spatial filter 852 may have a dual-polarization radiation pattern. The WBW spatial filter 852 may be associated with operating the CED in a beam-sweeping mode or a beam-acquisition mode, or a single broad beam mode (cf. TAB. 2).

The WBW spatial filter 852 may not be suitable for a closed-loop beam tracking mode of the FMP; rather, a comparatively narrow output beam 802 according to the spatial filter 851 may be preferable when operating in the closed-loop beam tracking mode.

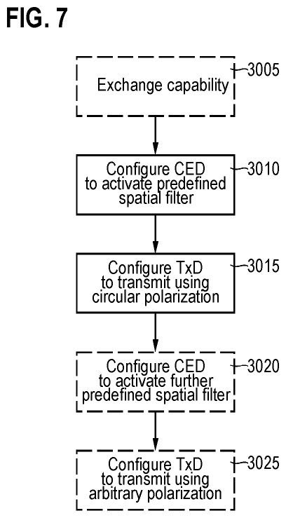

FIG. 7 is a flowchart of a method according to various examples. The method of FIG. 7 could be executed by a CED, e.g., the CED 109. More specifically, the method of FIG. 7 could be executed by the processor 1091 upon loading program code from the memory 1093 and upon executing the program code. It would also be possible that the method of FIG. 7 is executed by a device controlling the CED (cf. TAB. 1), e.g., by the BS 101 or the UE 102. For instance, the method of FIG. 7 could be executed by the processor 1011 upon loading program code from the memory 1015 and further upon executing the program code. The method of FIG. 7 could also be executed by the processor 1021 upon loading program code from the memory 1025 and further upon executing the program code.

Optional boxes are labeled using dashed lines in FIG. 7.

At optional box 3005, it is possible to exchange the capability of the participating devices to support a specific mode of the FMP that relies on WBW spatial filters at the CED that employ a dual-polarization radiation pattern. For instance, the capability to support WBW spatial filters that have been calculated using the iterative calculation according to TAB. 3 may be indicated.

For instance, box 3005 could include obtaining, from the CED and on a control link (cf. FIG. 4: control link 199), a capability message that is indicative of a capability of the CED to activate a respective predefined spatial filter.

Box 3005 could include providing, to a device controlling the CED, such a capability message.

By means of box 3005, the participating device can be made aware of whether the one or more WBW spatial filters that can be activated at the CED require the transmitter device to use a circular polarization of the electromagnetic waves of the transmitted signals. For instance, the capability message could include a list of codebook indicators of a codebook of spatial filters that are associated with spatial filters that require the TxD to use a circular polarization.

At box 3010, the CED is configured to activate a predefined spatial filter.

Box 3010 can, e.g., include providing an indicator indicative of the at least one predefined spatial filter to the CED on a control link. For instance, the control link could be between the TxD and the RD, or the RxD and the CED. I.e., box 3010 can include the act of control signaling between the involved devices to prepare the change of antenna settings at the CED.

Box 3010 can alternatively or additionally include adjusting settings of the multiple antennas at the CED. I.e., Box 3010 can include the act of the CED changing its antenna settings.

Next, at box 3015, upon configuring the CED to activate the at least one predefined spatial filter, the TxD is configured to transmit signals using a circular polarization of the electromagnetic waves.

For instance, by means of a capability message communicated at box 3005, the TxD may be aware that the at least one predefined spatial filter requires transmitting signals using the circular polarization.

Optionally box 3015 can include providing a respective control message to the TxD on a control link. For instance, by means of the control message, the CED could request the TxD to use the circular polarization.

More generally, a device controlling the CED can request the TxD to use the circular polarization, e.g., implicitly by indicating that the predefined spatial filter has been activated. I.e., box 3015 can include the act of control signaling between the involved devices to prepare the change of antenna settings at the TxD. Box 3015 can include adjusting settings of the antenna elements of the TxD, to thereby enable the circular polarization. I.e., Box 3015 can include the act of the TxD changing its antenna settings. For instance, where the device controlling the CED is the TxD, there is no need to provide a respective control message.

At box 3015, the TxD can also be configured to transmit the signals using a single data stream for the 2 orthogonal polarization components—i.e., L-CIR-POL or R-CIR-POL—of the circular polarization that is configured at box 3015. I.e., rank 1 transmission can be used.

Next, at box 3020, the CED can be configured to activate at least one further predefined spatial filter. This at least one further predefined spatial filter may not have a dual-polarization radiation pattern. It may be a non-WBW filter. The at least one further predefined spatial filter may not be calculated using the iterative calculation according to TAB. 3. For instance, the at least one further predefined spatial filter may define an output beam that has a comparatively small beamwidth, e.g., if compared to the beamwidth of the output beam defined by the at least one predefined spatial filter that is activated at box 3010. For instance, the filter 851 could be activated (cf. FIG. 5).

For instance, box 3020 may be executed upon transitioning from a single broad beam mode of the FMP or a beam sweeping mode of the FMP to a closed-loop beam tracking mode of the FMP (cf. TAB. 2).

Then, at box 3025, the TxD can be configured to transmit using an arbitrary polarization, e.g., a linear polarization or a circular polarization. The TxD may choose between both options.

At box 3025, it is possible to configure the TxD to transmit signals using independent data streams to the respective two orthogonal polarization components. Thereby, polarization multiplexing can be activated, e.g., using H-POL and V-POL, or R-CIR-POL and L-CIR-POL.

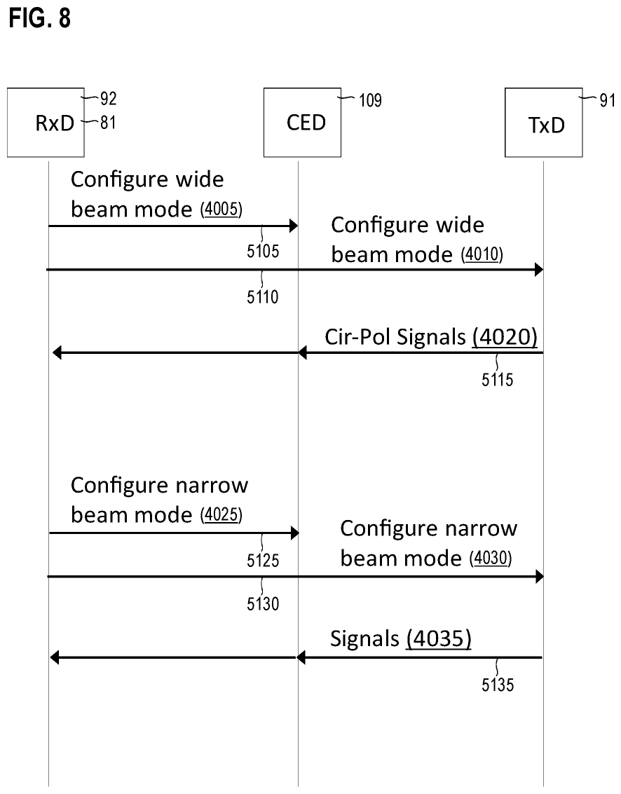

FIG. 8 is a signaling diagram of communication between a CED 109, a TxD 91 and a RxD 92. For instance, the TxD 91 could be implemented by the BS 101 or could be implemented by the UE 102. The RxD 92 also acts as a control device 81 of the CED 109 in the illustrated example (cf. TAB. 1: examples 1 and 2). The RxD 92 could be implemented by the BS 101 or could be implemented by the UE 102. The signaling of FIG. 8 can implement a method according to FIG. 7.

FIG. 8 illustrates a signaling that can be used for an UL wireless transmission where the BS controls the CED 109; i.e., the RxD 92 would be implemented by the BS 101 and the TxD 91 would be implemented by the UE 102.

At 5105, the RxD 92—in its capacity of control device 81—configures the CED 109 to activate at least one predefined spatial filter of multiple spatial filters, e.g., a WBW spatial filter. For instance, the RxD can transmit a control message to the CED 109 that is comprising an indicator that is indicative of the at least one predefined spatial filter. This can be on a control link 199. The indicator can be a codebook indicator that indicates a respective spatial filter from a respective codebook of spatial filters. The at least one spatial filter can be labeled as having a wide beamwidth in the respective filter codebook. The at least one predefined spatial filter can have a dual-polarization radiation pattern. The at least one spatial filter can provide, for a given output direction, different gains to the 2 orthogonal polarization components of a circular polarization that is used by the TxD 91 to transmit signals 4020 at 5115.

Upon receiving the control message 4005, the CED can adjust settings of its antenna elements accordingly.

Accordingly, 5105 implements box 3010 of the method of FIG. 7.

To ensure that the TxD 91 uses the circular polarization at 5115 when transmitting signals 4020, the RxD 92 can transmit, to the TxD 91 at 5110, a control message 4010 that is indicative of a respective request. For instance, a Layer 1 Downlink Control Indication could be transmitted on a Physical Downlink Control Channel (PDCCH), in case the RxD 92 is implemented by a Third Generation Partnership Project (3GPP) gNode B BS. Also Layer 3 control signaling, e.g., Radio Resource Control (RRC) control signalling would be possible.

Upon receiving this control message, the TxD 91 can adjust its settings of its antenna elements and then transmit the signals 4020 at 5115.

The TxD 91 transmits the signals 4020 using a single data stream over the two orthogonal linear polarization components of the circularly polarized signal.

Thus, 5110 implements box 3015 of the method of FIG. 7.

For instance, the FMP for configuring the spatial filter at the 109 may be in a beam sweeping mode or a single broad beam mode, according to TAB. 2 above, at 5105, 5110, and 5115.

The FMP of the CED 109 may then switch to a close loop beam tracking mode, according to TAB. 2 above, at 5125, 5130, and 5135.

In detail, at 5125, the RxD 92—again in its capacity as control device 81—may then configure a narrow beam mode at the CED 109, by transmitting a respective control message 4025. This activates at least one further predefined spatial filter at the CED 109. For instance, different codebook indicator can be signaled if compared to 5105. The respective further predefined spatial filter may not be labeled in the filter codebook as defining an output beam having a wide beamwidth. The at least one further predefined spatial filter may not be a dual-polarization radiation pattern. The at least one further predefined spatial filter may be a non-WBW spatial filter.

Accordingly, there may not be a requirement of the TxD 91 to use a circular polarization. At 5130, the RxD 92 signals, to the TxD 91, using control message 4030, that a narrow beam mode is activated. This may relieve the TxD 91 from the need to use a circular polarization when transmitting further signals 4035 at 5135 (the further signals 4035 may or may not be transmitted using a circular polarization).

For instance, the TxD 91 may be configured to transmit the further signals using multiple data streams for the two orthogonal polarization components of the circular or linear polarization then used for the electromagnetic waves.

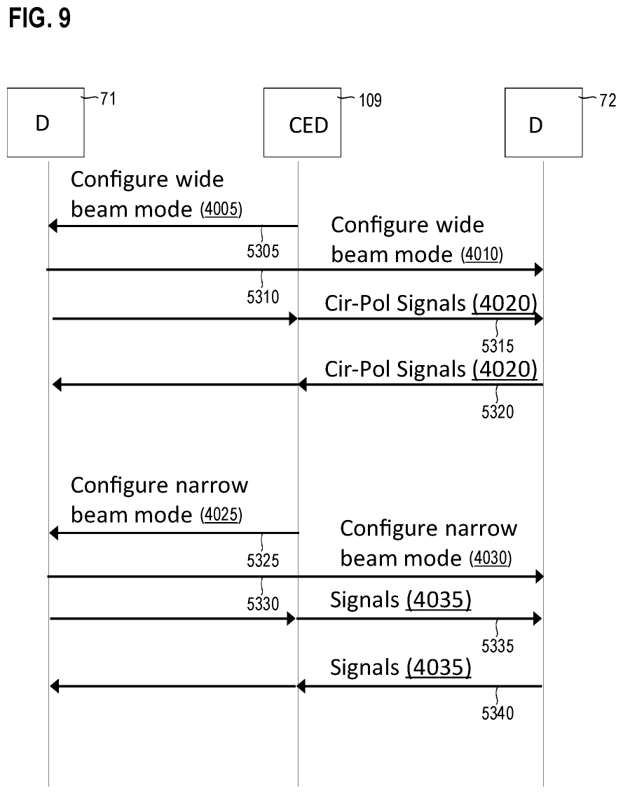

FIG. 9 is a signaling diagram of communication between a CED 109 and two devices 71, 72 of a communication system. For instance, the device 71 may be implemented by the BS 101 or the UE 102; and the device 72 may be implemented by the UE 102 or the BS 101, respectively.

The CED 109, in the example of FIG. 9, selects its spatial filters autonomously (cf. TAB. 1: example 3).

The scenario FIG. 9 is helpful where a control link is only established between the CED 109 and the device 71, but not directly between the CED 109 and the device 72.

Accordingly, a control message 4005 that is indicative of the activation of the at least one predefined spatial filter—as discussed in connection with box 3010 of FIG. 7—is transmitted by the CED 109 to the device 71 at 5305. Also, the CED 109 adjusts settings of its antenna elements to activate the at least one predefined spatial filter. This implements box 3010 of the method of FIG. 7.

The device 71 can inform the device 72 using a respective control message 4010 at 5310. The device 71 can then, at 5315, transmit signals 4020 to the device 72 using circular polarization of the respective electromagnetic waves and limited to rank 1; alternatively, device 72 can match its polarization to the polarization of the received signals 4020; and, likewise, at 5320, the device 72 can transmit signals 4020 using a circular polarization limited to rank 1. This implements box 3015 of the method of FIG. 7.

At 5325, the CED 109 can then activate the narrow beam mode by activating a respective spatial filter and informs the device 71 using a respective control message 4025. This implements box 3020 of the method of FIG. 7.

The device 71 can inform the device 72 using a respective control message 4030 at 5330. The device 71 can then transmit further signals 4035 at 5335 using an arbitrary polarization using rank 1 or higher; similarly, the device 72 can transmit further signals 4035 at 5340 using an arbitrary polarization using rank 1 or higher. This implements box 3025.

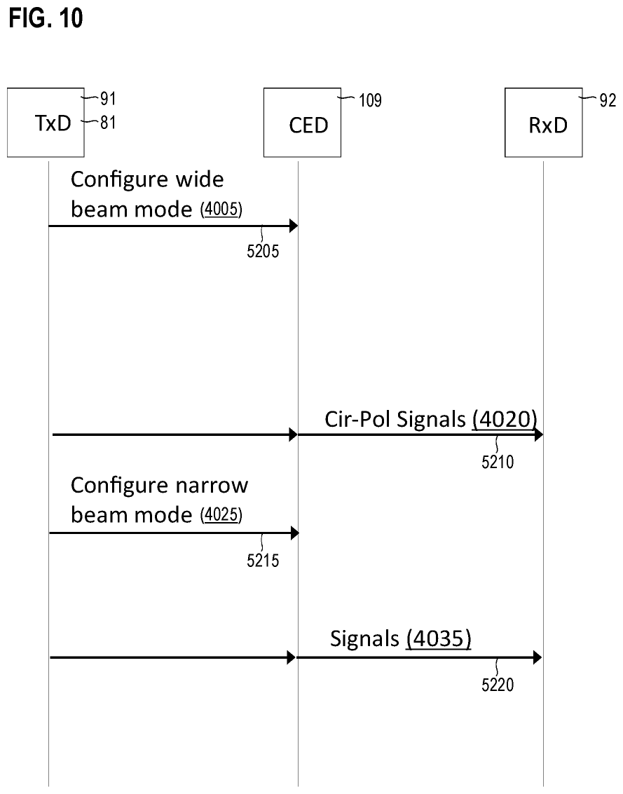

FIG. 10 is a signaling diagram between a CED 109, a TxD 91, and a RxD 92. For instance, the TxD 91 could be implemented by the BS 101 or could be implemented by the UE 102. The RxD 92 could be implemented by the UE 102 or the BS 101, respectively.

In the scenario of FIG. 10, the TxD 91 implements the control device 81 that configures the CED 109 (cf. TAB. 1, examples 1 and 2). An example use case would be a downlink wireless transmission where the BS 101 controls the CED 109.

FIG. 10 thus somewhat corresponds to an inverted scenario of FIG. 8.

At 5205, the TxD 91 configures the CED to activate the at least one predefined spatial filter; a respective control message 4005 is used. Respective aspects have been described in connection with 5105 and FIG. 8. Thus, 5205 implements box 3010 of the method of FIG. 7.

The TxD 91, at 5210, can then transmit signals 4020 using a circular polarization of the respective electromagnetic waves.

Thus, 5210 implements box 3015 of the method of FIG. 7.

At 5215, the TxD 91 configures the CED 109 to activate a narrow beam mode using a respective control message 4025. Respective aspects have been described above in connection with FIG. 8:5125. This implements box 3020 of the method of FIG. 7.

The TxD 91, at 5220, then transmits further signals 4035 to the RxD 92 via the CED 109 using either a circular polarization or a linear polarization of the electromagnetic waves.

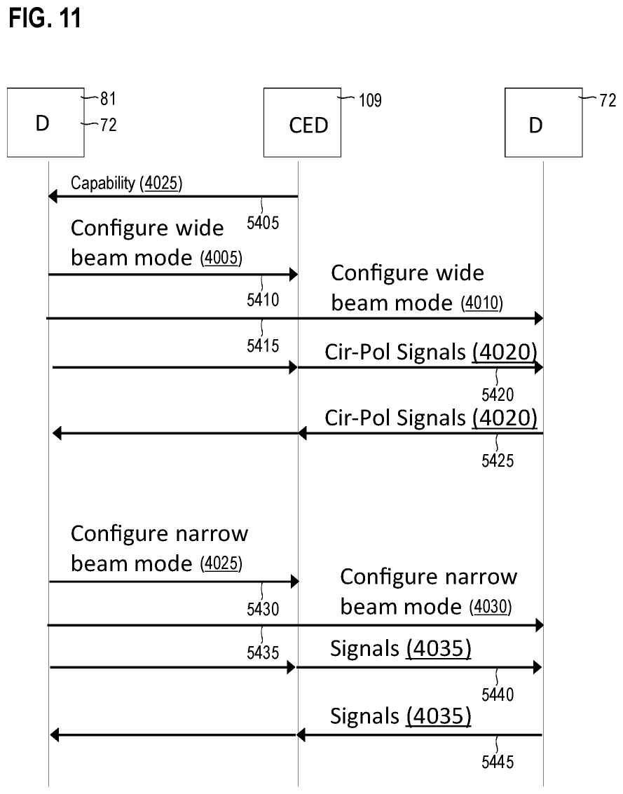

FIG. 11 is a signaling diagram of communication between a CED 109 and two devices 71, 72 of a communication system. For instance, the device 71 may be implemented by the BS 101 or the UE 102; and the device 72 may be implemented by the UE 102 or the BS 101, respectively. The device 71 implements a control device 81 that configured the CED 109.

FIG. 11 corresponds to a combination of FIG. 8 and FIG. 10.

At 5405, the CED 109 indicates its capability to use WBW spatial filters. For instance, the CED 109 could indicate certain codebook entries that would require the TxD to use a circular polarization.

At 5410, a control message 4005 that is indicative of the activation of the at least one predefined spatial filter—as discussed in connection with box 3010 of FIG. 7—is transmitted by the control device 81 to the CED 109. Also, the CED 109 adjusts settings of its antenna elements to activate the at least one predefined spatial filter. This implements box 3010 of the method of FIG. 7.

The device 71 can inform the device 72 using a respective control message 4010 at 5415. The device 71 can then, at 5420, transmit signals 4020 to the device 72 using circular polarization of the respective electromagnetic waves and limited to rank 1; and, likewise, at 5425, the device 72 can transmit signals 4020 using a circular polarization limited to rank 1. This implements box 3015 of the method of FIG. 7.

At 5430, the control device 81 can then activate the narrow beam mode by transmitting a respective control message 4025; the CED 109 activates a respective spatial filter. This implements box 3020 of the method of FIG. 7.

The device 71 can inform the device 72 using a respective control message 4030 at 5435. The device 71 can then transmit further signals 4035 at 5440 using an arbitrary polarization using rank 1 or higher; similarly, the device 72 can transmit further signals 4035 at 5445 using an arbitrary polarization using rank 1 or higher. This implements box 3025. Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

1. A method of supporting a wireless transmission from a transmitter device via a coverage enhancing device to a receiver device, the coverage enhancing device being reconfigurable to provide multiple spatial filters by applying, at multiple antenna elements, one or more phase shifts to electromagnetic waves of signals of the wireless transmission, each one of the multiple antenna elements of the coverage enhancing device being associated with a respective one of two orthogonal polarization components of a polarization of the electromagnetic waves,
wherein the method comprises:
configuring the coverage enhancing device to activate at least one predefined spatial filter of the multiple spatial filters, and
upon configuring the coverage enhancing device to activate the at least one predefined spatial filter, configuring the transmitter device to transmit the signals using a circular polarization of the electromagnetic waves.

2. The method of claim 1, wherein the at least one predefined spatial filter is labeled, in a respective filter codebook, as defining an output beam having a wide beamwidth.

3. The method of claim 1, wherein the at least one predefined spatial filter has a dual-polarization radiation pattern.

4. The method of claim 1, wherein the at least one predefined spatial filter provides, for a given output direction, different gains to the two orthogonal polarization components of the circular polarization of the electromagnetic waves of the transmitted signals.

5. The method of claim 1, wherein the at least one predefined spatial filter is associated with operating the coverage enhancing device in at least one of a beam-sweeping mode, a beam-acquisition mode, or a broadcasting mode.

6. The method of claim 1, wherein the at least one predefined spatial filter is associated with not operating the coverage enhancing device in a closed-loop beam tracking mode.

7. The method of claim 1, wherein said configuring of the coverage enhancing device comprises at least one of providing, to the coverage enhancing device, an indicator indicative of the at least one predefined spatial filter on a control link between the coverage enhancing device and at least one of the transmitter device or the receiver device, or adjusting settings of the multiple antenna elements at the coverage enhancing device.

8. The method of claim 1,
wherein a base station of a cellular network implements the receiver device,
wherein a wireless communication device connected to the cellular network implements the transmitter device,
wherein said configuring of the coverage enhancing device comprises providing, by the base station and to the coverage enhancing device, an indicator indicative of the at least one predefined spatial filter on a control link between the coverage enhancing device and the base station.

9. The method of claim 1, further comprising:
obtaining, from the coverage enhancing device and on a control link, a capability message indicative of a capability of the coverage enhancing device to activate the at least one predefined spatial filter.

10. The method of claim 1, further comprising:
upon configuring the coverage enhancing device to activate the at least one predefined spatial filter, configuring the transmitter device to transmit the signals using a single data stream for the two orthogonal polarization components of the circular polarization.

11. The method of claim 1, wherein said configuring of the transmitter device comprises at least one of providing a respective control message to the transmitter device on a control link between the transmitter device and at least one of the coverage enhancing device or the receiver device, or adjusting precoding settings of multiple further antenna elements of the transmitter device.

12. The method of claim 1,
wherein a base station of a cellular network implements the receiver device,
wherein a wireless communication device connected to the cellular network implements the transmitter device,
wherein said configuring of the transmitter device comprises providing, from the base station to the wireless communication device, a respective control message on a control link between the base station and the wireless communication device.

13. The method of claim 1, wherein the method further comprises:
after configuring the coverage enhancing device to activate the at least one predefined spatial filter, configuring the coverage enhancing device to activate at least one further predefined spatial filter of the multiple spatial filters, and
upon configuring the coverage enhancing device to activate the at least one further predefined spatial filter, configuring the transmitter device to transmit the signals using multiple data streams for two orthogonal polarization components of the polarization of the electromagnetic waves.

14. The method of claim 12, wherein the at least one further spatial filter is associated with operating the coverage enhancing device in a closed-loop beam tracking mode.

15. The method of claim 1, wherein the method is implemented by at least one of the transmitted device, the receiver device, or the coverage enhancing device.

16. A device for supporting a wireless transmission from a transmitter device via a coverage enhancing device to a receiver device, the coverage enhancing device being reconfigurable to provide multiple spatial filters by applying, at multiple antenna elements, one or more phase shifts to electromagnetic waves of signals of the wireless transmission, each one of the multiple antenna elements of the coverage enhancing device being associated with a respective one of two orthogonal polarization components of a polarization of the electromagnetic waves,
wherein the device comprises a processor configured to:
configure the coverage enhancing device to activate at least one predefined spatial filter of the multiple spatial filters, and
upon configuring the coverage enhancing device to activate the at least one predefined spatial filter, configure the transmitter device to transmit the signals using a circular polarization of the electromagnetic waves.

17. (canceled)
